(19) United States
(12) Patent Application Publication
(10) Pub. No.: US 2005/0226322 A1
(43) Pub. Date: Oct. 13, 2005

(54) Non-scalable to scalable video conversion method, scalable to non-scalable video conversion method

(76) Inventors: Renatus J. Van Der Vleuten, NM VELDHOVEN (NL); Anthony Morel, Shangai (CN)

Correspondence Address: PHILIPS INTELLECTUAL PROPERTY & STANDARDS, P.O. BOX 3001, BRIARCLIFF MANOR, NY, 10510, US

(21) Appl. No.: 10/515,744

(22) PCT Filed: Jun. 4, 2003
(86) PCT No.: PCT/IB03/02528

§ 371 Date: Nov. 24, 2004

(30) Foreign Application Priority Data
May 31, 2002 (EP) 02291341.2

(51) Int. Cl. H04N 7/12

(52) U.S. Cl. 375/240.08; 375/240.1; 375/240.24; 375/240.18; 375/240.23; 375/240.03

(57) ABSTRACT

The invention relates to a cost-effective method of modifying a non-scalable coded video signal for generating a scalable coded video signal comprising a base layer and a set of enhancement layers. The base layer results from a bit shift performed by a shift matrix applied on coefficients, and an extraction of a reduced number of least significant bit planes. The enhancement layers result from the bit-plane coding of the least significant bit planes. Contrary to a requantization method that would identically truncate all coefficients in a block and would cause visual artifacts, the shift matrix allows a progressive attenuation of the coefficients. The base layer is then composed of dampened coefficients. The invention also relates to a cost-effective method of modifying said scalable coded video signal for generating a non-scalable coded video signal.

### FIELD OF THE INVENTION

The invention relates to a method of modifying a non-scalable coded video signal for generating a scalable coded video signal.

The invention also relates to a method of modifying a scalable coded video signal for generating a non-scalable coded video signal.

The invention may be used in the field of digital video processing.

### BACKGROUND OF THE INVENTION

The use of coded video signals is now widespread in many applications, in particular applications using video signals coded in accordance with the MPEG-2 or MPEG-4 video standard, or with a wavelet transform coding.

To ease the manipulation of coded video signals, first at the consumer side from a storage point of view, and secondly during their transmission on communication channels such as the Internet network from a bitrate point of view, video coding methods have been developed for generating scalable coded video signals.

Scalable coded video signals comprise a base layer having a low bitrate, said base layer being coded, for example, in accordance with the MPEG-2 or MPEG-4 video standard, and a set of enhancement layers of lower and decreasing quality. The overall quality of the video signal is shared between the base layer and the enhancement layers. Thus, the storage capacity of coded video signals at the consumer side can be increased by suppressing one or a plurality of enhancement layers. Similarly, one or a plurality of enhancement layers can be suppressed to fit with the bandwidth capacity of the communication channel.

The MPEG-4 video standard describes an encoding method of generating a scalable coded video signal from an input video signal in the pixel domain. This method is also described in the article entitled “Overview of Fine Granularity Scalability (FGS) in MPEG-4 video standard”, IEEE TRANSACTIONS ON CIRCUITS AND SYSTEMS FOR VIDEO TECHNOLOGY, VOL. 1, NO. 3, MARCH 2001.

This encoding method is depicted in FIG. 1 in which a video signal 101 in the pixel domain is encoded by the set of processing steps 102 for generating the scalable coded video signal comprising a base layer 103 and a set of enhancement layers 104.

This article also describes a decoding method of decoding such a scalable coded video signal 201. This decoding method is depicted in FIG. 2 in which a scalable coded video signal comprising a base layer 203 and a set of enhancement layers 202 is decoded by the set of processing steps 204 for generating the decoded video signal 205.

The encoding method according to the prior art suffers from limitations because it cannot be used for directly generating a scalable coded signal from a non-scalable coded video signal, for example, from a video signal coded in accordance with the MPEG-2 standard.

Since the use of non-scalable coded video signals as input signals is now widespread in many applications, for example, in consumer or broadcasting devices, it becomes an interesting feature to directly generate a scalable coded signal from a non-scalable coded video signal.

Basically, if the method as described in the prior art is used for generating a scalable coded signal from a non-scalable coded video signal, an additional decoding step of said non-scalable coded video signal must first be performed before applying the encoding step. The decoding step may consist of a standard decoding, for example, by using an MPEG-2 standard decoder.

For fast processing, this additional decoding step requires a large amount of processing resources, which leads to an expensive solution that limits its use in consumer products. On the contrary, if processing resources are intentionally limited, the processing becomes too slow for use in real-time applications.

The encoding step comprises a motion compensation step that avoids the drift quality on the base layer. However, the motion compensation step does not only consume in terms of processing resources, but also in terms of memory storage capacity, which makes the encoding method expensive in itself.

Moreover, the cascading of a decoding step and an encoding step is not optimal in terms of coding quality because encoding parameters may differ from coding parameters of the original non-scalable coded video signal. As a consequence, this solution leads to a loss of video quality and generates artifacts in the generated scalable coded video signal.

### OBJECT AND SUMMARY OF THE INVENTION

It is an object of the invention to propose a first cost-effective video modifying method of generating a scalable coded video signal of better quality from a non-scalable coded video signal. This method is dedicated for video signals containing blocks of input coefficients, said blocks comprising for example either DCT coefficients in case of block-based video coding, or wavelet coefficients in case of wavelet-based video coding.

The invention relates to a method of modifying a non-scalable input coded video signal comprising blocks of input coefficients, said input coefficients being quantized by an input quantization factor, for generating a scalable output coded video signal comprising a base layer and a set of enhancement layers. The method of modifying is characterized in that it comprises:
a first bit-shifting step applied to said input coefficients, said first bit-shifting step consisting of shifting to the left the bits by a quantity given by the coefficients of a shift matrix, for generating primary shifted coefficients,
a second bit-shifting step applied to said primary shifted coefficients, said second bit-shifting step consisting of shifting to the right the bits by a quantity N1, for generating secondary shifted coefficients,
a variable-length coding step applied to said secondary shifted coefficients, for generating variable-length coded coefficients defining said base layer,
a bit-plane coding step for coding the bit planes composed from the N1 least significant bits of said primary shifted coefficients, for generating coded bit planes defining said enhancement layers.

In a preferred mode, the first method of modifying is characterized in that N1 corresponds to the larger coefficient in said shift matrix.

This method of modifying allows generation of a scalable coded video signal comprising a base layer and a set of enhancement layers.

The base layer results from a modification of the coefficient values of the non-scalable coded video signal, the other coding parameters (motion vectors, frame type . . . ) remaining the same. The bitrate of the base layer is reduced compared as the bitrate of said non-scalable coded video signal. The bitrate reduction is performed by use of the shift matrix directly applied to coefficients, leading to a truncation of the least significant bits (LSBs) of the coefficients. Contrary to a method based on a requantization step of coefficients that would identically truncate all coefficients in a block and would cause visual artifacts, the shift matrix allows a progressive attenuation of the coefficients, in attenuating preferably coefficients of high frequency. Dampened coefficients are then obtained. Thus, while getting a base layer having a reduced bitrate, the base layer maintains a good quality because video details of low frequency are preserved.

This method does not use a motion compensation step, which contributes to a cost-effective solution. The attenuation of coefficients leads to a drift quality in the base layer, but considering that this attenuation preferably concerns high frequency coefficients to which the human eye is not sensitive, the drift quality is not visually perceptible in the decoded base layer.

The set of enhancement layers is generated from the coding of bit planes composed from the LSBs of each truncated coefficient. In particular, if bit planes are encoded separately, each coded bit plane may constitute an enhancement layer.

This method allows exact recovery of the video quality of the non-scalable coded video signal by addition of the base layer and all enhancement layers of said set of enhancement layers.

In case some enhancement layers are lost during their transmission on a communication channel, the decoded video quality still remains acceptable because the base layer itself is composed of dampened coefficients, which reduces the quality drift. In such a case, the solution according to the invention represents an important improvement compared to prior art solutions where the coefficients of the base layer are not dampened but simply requantized (i.e. a uniform truncation without taking into account the frequency distribution), which dramatically leads to an important quality drift and to a perceptual quality that quickly drops.

The use of a bit-plane coding allows a fine granularity of the scalable coded video signal because enhancement layers result from the coding of bit planes of decreasing rank in said LSBs. When used in applications in order to fit with a storage capacity or a channel bandwidth capacity, the suppression of one or a plurality of enhancement layers can take place progressively. In particular, enhancement layers containing the finest details, i.e. corresponding to the LSBs bit planes, are suppressed first.

Most processing steps consist of bit shifting binary data, which also contributes to a cost-effective solution and to an easy implementation by means of shift registers.

The bit rate of the base layer may easily be changed, by changing coefficients of the shift matrix, which gives flexibility to this method.

Advantageously, an adaptive change of the shift matrix coefficients can be performed for reaching a given bit rate target of the base layer. Such an adaptive change of the shift matrix coefficients can particularly be based on the value of the quantization factor being used for the coded picture, the complexity of the coded picture, or the coded picture type.

In a preferred mode, the first method of modifying is characterized in that:
N1 corresponds to the addition of a quantity K to the larger coefficient in said shift matrix,
it comprises a requantization step for requantizing the input quantization factor, for generating a requantized output quantization factor, said requantization step consisting of multiplying the input quantization factor by a factor equal to 2^{K}.

The base layer results from a modification not only of the coefficient values but also of the quantization factor of the non-scalable coded video signal, the other coding parameters (motion vectors, frame type . . . ) remaining the same. This preferred mode allows generation of a base layer with a much more reduced bitrate. This is done by truncating all coefficients in blocks, even low frequency coefficients, and by performing a requantization step applied to the quantization factor.

This requantization step consists of a multiplication by a power of two of the input quantization factor. This solution is cost-effective because this multiplication can be performed by a bit shifting of said quantization factor.

Similarly, all bits of coefficients that are truncated are bit plane encoded, which allows exact recovery of the video quality of the non-scalable coded video signal by addition of the base layer and said enhancement layers.

It is also an object of the invention to propose a second cost-effective video modifying method of generating a non-scalable output video signal from a scalable input coded video signal generated by the first method of modifying according to the invention when no requantization has been performed. This method is dedicated for video signals containing blocks of input coefficients, said blocks comprising for example either DCT coefficients in case of block-based video coding, or wavelet coefficients in case of wavelet-based video coding.

Dealing with a scalable signal, it is assumed that enhancement layers resulting from the coding of the most significant bit planes are received and used in the decoding process before enhancement layers resulting from the coding of the least significant bit planes.

The invention relates to a method of modifying a scalable input coded video signal comprising a base layer and a set of enhancement layers, for generating a non-scalable output video signal, said base layer comprising blocks of input coefficients. The method of modifying is characterized in that it comprises the following recursive set of steps, for each enhancement layer:
a bit-shifting step applied to said input coefficients, said bit-shifting step consisting of shifting to the left by one unit the bits of input coefficients considered as being dampened, for generating primary shifted coefficients,
a bit-plane decoding step for decoding the enhancement layer, for generating a decoded bit plane defining primary decoded values,
an addition step for adding said primary shifted coefficients to said primary decoded values, for generating decoded values defining the non-scalable output video signal, the set of recursive steps being performed a number of times equal to the number of enhancement layers.

For each successive enhancement layer, this second modifying method consists of inserting, in the LSBs of the input and dampened coefficients of the base layer, the bits of the bit plane defining said enhancement layer. The same process is repeated recursively on the resulting modified coefficients for all enhancement layers available. Once this set of recursive steps is finished, the modified coefficients define the non-scalable video signal.

Since the non-dampened coefficients remain the same, this method is efficient in terms of processing resources.

If all enhancement layers are received by the decoding process, the resulting non-scalable video signal is exactly the same as the non-scalable input coded video signal generated by the first modifying method.

If only a reduced number of enhancement layers is available, the decoded video quality still remains acceptable because the base layer itself is composed of dampened coefficients and not of requantized coefficients. In that case, this method ensures an acceptable video quality.

It is also an object of the invention to propose a third cost-effective video modifying method of generating a non-scalable output video signal from a scalable input coded video signal generated by the first method of modifying according to the invention when a requantization has been performed.

The invention relates to method of modifying a scalable input coded video signal comprising a base layer and a set of enhancement layers, for generating a non-scalable output video signal, said base layer comprising blocks of input coefficients quantized by an input quantization factor. The method of modifying is characterized in that it comprises:
a) a first set of recursive steps comprising, for each enhancement layer:
   a first bit-shifting step applied to said input coefficients, said first bit-shifting step consisting of shifting to the left by one unit the bits of input coefficients, for generating primary shifted coefficients,
   a bit-plane decoding step for decoding the enhancement layer, for generating a decoded bit plane defining primary decoded values,
   a first addition step for adding, the primary decoded values to said primary shifted coefficients, for generating modified coefficients,
a requantization step for requantizing the input quantization factor and generating an output quantization factor, said requantization step consisting of dividing the input quantization factor by two, the first set of recursive steps being performed at a maximum a number of times equal to a given quantity K,
b) a second set of recursive steps comprising, for each enhancement layer:
   a second bit-shifting step applied to said modified coefficients, said second bit-shifting step consisting of shifting to the left by one unit the bits of modified decoded coefficients considered as being dampened, for generating secondary shifted coefficients,
   a bit-plane decoding step for decoding the enhancement layer for generating a decoded bit plane defining secondary decoded values,
   a second addition step for adding said secondary shifted coefficients to said secondary decoded values, for generating decoded values defining the non-scalable output video signal,
      the second set of recursive steps being performed a number of times equal to the remaining enhancement layers.

For each successive enhancement layer, this second modifying method comprises a first set of recursive steps that consists of inserting, in the LSBs of all input coefficients of the base layer, the bits of the bit plane defining said enhancement layer. The same process is repeated recursively on the resulting modified coefficients for all enhancement layers available considered as resulting from a requantization. Simultaneously, each time an enhancement layer is inserted, the quantization factor associated with the coefficients is halved.

The processing is continued by a second set of recursive steps applied on the modified coefficients resulting from the first set of recursive steps. The second set of recursive steps consists of inserting, in the LSBs of the dampened coefficients, the bits of the bit plane defining said enhancement layer. The same process is repeated recursively on the resulting modified coefficients for all enhancement layers available. Once this second set of recursive steps is finished, the modified coefficients define the non-scalable video signal.

This third method of modifying allows modification of a scalable coded video signal having coefficients that are requantized and dampened.

In the second set of recursive steps, this method is efficient in terms of processing resources, because the non-dampened coefficients remain the same.

If all enhancement layers are received by the decoding process, the resulting non-scalable video signal is exactly the same as the non-scalable input coded video signal generated by the first modifying method.

If only a reduced number of enhancement layers is available, the decoded video quality still remains acceptable because the base layer itself is composed of dampened coefficients and not only composed of requantized coefficients. In that case, this method ensures an acceptable video quality.

In a preferred mode, the second and third methods of modifying are characterized in that they comprise:
a variable-length coding step applied to said decoded values defining the output video signal, for generating variable-length coded coefficients,
a standard video decoding step for decoding said variable-length coded coefficients, for generating a decoded video signal of said non-scalable output video signal.

The use of a variable-length coding step allows decoding of the non-scalable output video signal by means of a standard video decoding method, for example, a MPEG-2 or MPEG-4 video standard decoding method.

The invention also relates to an encoder comprising hardware and software means for implementing the steps of the first method of modifying described above.

The invention also relates to a decoder comprising hardware and software means for implementing the steps of the second or third method of modifying described above.

The invention also relates to a set top box product including a decoder which comprises hardware and software means for implementing the steps of the second or third method of modifying described above.

The invention also relates to a scalable coded signal generated by means of the first method of modifying according to the invention.

The invention also relates to concerns a storage medium carrying a scalable coded signal generated by means of the first method of modifying according to the invention.

The invention also relates to a first computer program comprising code instructions for implementing the steps of the first method of modifying according to the invention presented above, said first computer program being used by a signal processor.

The invention also relates to a second computer program comprising code instructions for implementing the steps of the second method of modifying according to the invention presented above, said second computer program being used by a signal processor.

The invention also relates to a third computer program comprising code instructions for implementing the steps of the third method of modifying according to the invention presented above, said third computer program being used by a signal processor.

Detailed explanations and other aspects of the invention will be given below.

### BRIEF DESCRIPTION OF THE DRAWING

The particular aspects of the invention will now be explained with reference to the embodiments described hereinafter and considered in connection with the accompanying drawings, in which identical parts or sub-steps are designated in the same manner:

FIG. 1 is a diagram depicting the steps of a known method of generating a scalable coded video signal from a non-scalable video signal,

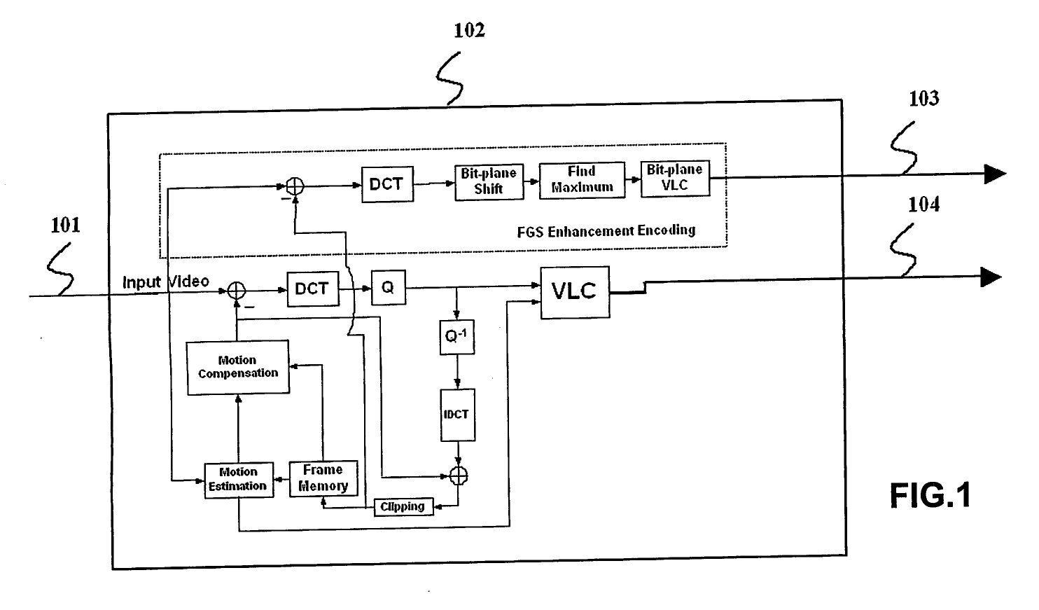

FIG. 2 is a diagram depicting the steps of a known method of generating a decoded non-scalable video signal from a scalable coded video signal,

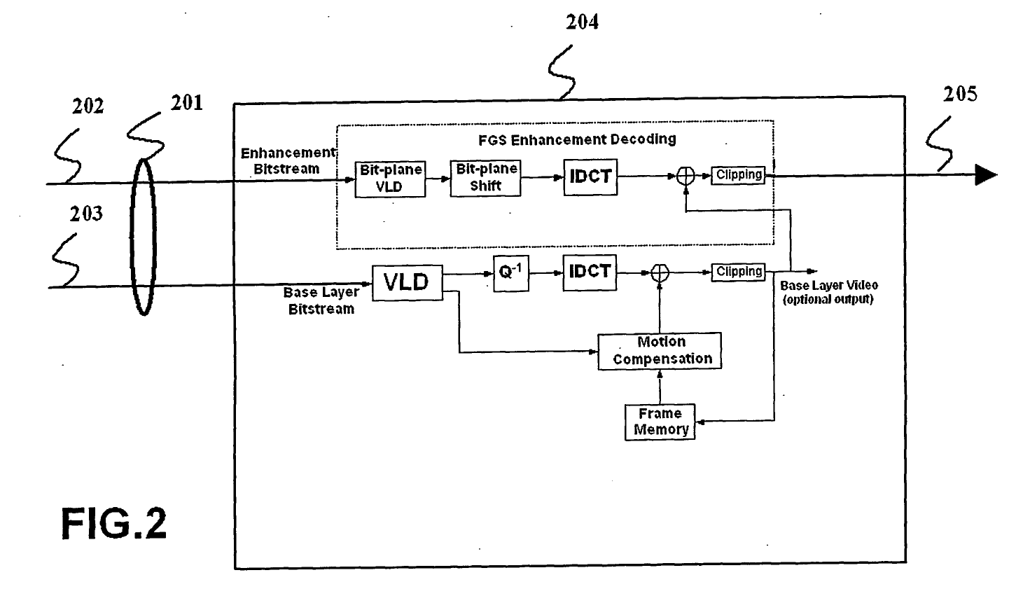

FIG. 3 is a diagram depicting the steps of a first method according to the invention for generating a scalable coded video signal from a non-scalable coded video signal,

FIG. 4 is a diagram depicting the steps of a variant of the first method according to the invention including a requantization step,

FIG. 5 depicts examples of shift matrixes used in the methods of modifying according to the invention,

FIG. 6 is a diagram depicting the steps of a second method according to the invention for generating a non-scalable coded video signal from a scalable coded video signal generated by means of said first method,

FIG. 7 is a diagram depicting the steps of a third method according to, the invention for generating a non-scalable coded video signal from a scalable coded video signal generated by means of said first method.

### DETAILED DESCRIPTION OF THE INVENTION

In the following, the invention will be described assuming that video signals are block-based coded (for example derived from a MPEG-based video coding), blocks comprising DCT (Discrete Cosine Transform) coefficients. However, this method is not limited to video signals comprising DCT coefficients, but could also be applied to video signals comprising wavelet coefficients, or coefficients derived from another video coding.

Similarly, the invention will be described assuming that the input coefficients of video signals are variable-length coded coefficients. A variable-length decoding step is thus done in that case. However, this method is not limited to such input coefficients and could also be applied to input coefficients which are not variable-length coded. A variable-length decoding step would thus not be useful in that case.

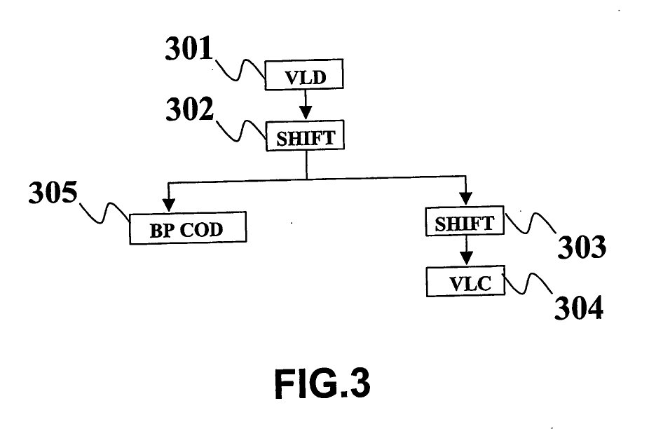

FIG. 3 is a diagram depicting the steps of a method according to the invention for generating a scalable coded video signal from a non-scalable coded video signal.

The non-scalable coded video signal is a signal comprising blocks of 8*8=64 DCT coefficients quantized by an input quantization factor, and coded, for example, in accordance with the MPEG-2 or MPEG-4 video standard.

This method comprises a variable-length decoding step 301 applied to said DCT coefficients, for generating variable-length decoded DCT coefficients. This step may consist of a look-up table operation between an input DCT coefficient resulting from a coding using, for example, Huffman codes, and an output DCT coefficient.

This method also comprises a first bit-shifting step 302 applied to said variable-length decoded DCT coefficients, said first bit-shifting step consisting of shifting to the left the bits by a quantity given by the coefficients of a shift matrix, for generating primary shifted DCT coefficients. Each DCT coefficient in a given DCT block situated at a given row and column is associated with the shift coefficient in the shift matrix having the same row and column. When a DCT coefficient is shifted to the left, the new LSBs are filed with zeros.

This method comprises a second bit-shifting step 303 applied to said primary shifted DCT coefficients, said second bit-shifting step consisting of shifting to the right the bits by a quantity N1, for generating secondary shifted DCT coefficients. The shift to the right of N1 units is applied to all DCT coefficients in order to define the DCT coefficients defining the base layer.

The quantity N1 corresponds to the larger shift coefficient Smax in the shift matrix. As a consequence, the larger shift coefficients are, the less the corresponding DCT coefficients are dampened by the second bit-shifting step.

This method also comprises a variable-length coding step 304 applied to said secondary shifted DCT coefficients, for generating variable-length coded DCT coefficients defining said base layer with an improved coding efficiency. This step may consist of a look-up table operation between an input DCT coefficient and an output DCT coefficient resulting from a coding using, for example, Huffman codes. It allows a decrease of the number of bits of the base layer.

This method also comprises a bit-plane coding step 305 applied to the N1=Smax bit planes composed from the N1 least significant bits of said primary shifted DCT coefficients, for generating coded bit planes defining N1 enhancement layers.

To this end, bit planes can be converted in 2-D symbols by the known coding method (RUN, EOP) as described in the MPEG-4 standard document referred to as ISO/IEC 14496-2/AMD 4. This method comprises the following steps:
a counting step for counting the number of consecutive 0's before a 1 (RUN),
whether there are any 1's left on this bit plane, i.e. an End-Of-Plane (EOP) detecting step. If a bit plane after the most significant bit planes (MSB) contains all 0's, a special symbol ALL-ZERO is formed to represent an all-zero bit-plane.

For example, let us consider the set of 64 data each composed by the N1 least significant bits of the primary shifted DCT coefficients (10, 0, 6, 0, 0, 3, 0, 2, 2, 0, 0, 2, 0, 0, 1, 0, . . . 0, 0) expressed in decimal value or (1010, 0000, 0110, 0000, 0000, 0011, 0000, 0010, 0010, 0000, 0000, 0010, 0000, 0000, 0001, 0000, . . . 0000, 0000) expressed in binary value. Four bit planes are thus defined as follows:

| | |
|---|---|
| (1, 0, 0, 0, 0, 0, 0, 0, 0, 0, 0, 0, 0, 0, 0, 0, . . . 0, 0) | (bit plane 1) |
| (0, 0, 1, 0, 0, 0, 0, 0, 0, 0, 0, 0, 0, 0, 0, 0, . . . 0, 0) | (bit plane 2) |
| (1, 0, 1, 0, 0, 1, 0, 1, 1, 0, 0, 1, 0, 0, 0, 0, . . . 0, 0) | (bit plane 3) |
| (0, 0, 0, 0, 0, 1, 0, 0, 0, 0, 0, 0, 0, 0, 1, 0, . . . 0, 0) | (bit plane 4) |

Coding the bits of the four bit-planes into (RUN, EOP) symbols leads to:

| | |
|---|---|
| (0, 1) | (coded bit plane 1) |
| (2, 1) | (coded bit plane 2) |
| (0, 0), (1, 0), (2, 0), (1, 0), (0, 0), (2, 1) | (coded bit plane 3) |
| (5, 0), (8, 1) | (coded bit plane 4) |

Each 2-D symbol can thus be passed through a variable-length coding (VLC) step by means of a look-up table assigning a VLC code to each 2-D symbol.

For the bit-plane coding step, other methods can also be used, such as a method which avoids sending zeros situated at the beginning of the bit plane, leading to a better efficiency. Such a method is described in European Patent referred to as EP 01204442.6.

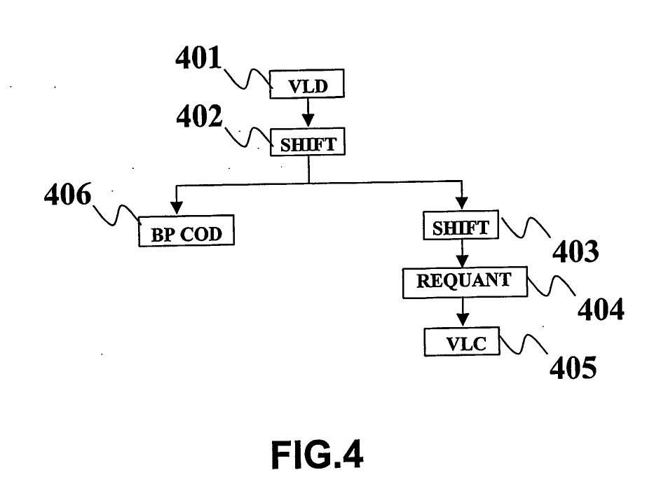

FIG. 4 is a diagram depicting the steps of a variant of the first method according to the invention including a requantization step. This method is directly derived from the method depicted in FIG. 3 but differs in that it comprises a requantization step.

The non-scalable coded video signal is a signal comprising blocks of 8*8=64 DCT coefficients quantized by an input quantization factor, and coded, for example, in accordance with the MPEG-2 or MPEG-4 video standard.

This method comprises a variable-length decoding step 401 applied to said DCT coefficients, for generating variable-length decoded DCT coefficients. This step may consist of a look-up table operation between an input DCT coefficient resulting from a coding using, for example, Huffman codes, and an output DCT coefficient.

This method also comprises a first bit-shifting step 402 applied to said variable-length decoded DCT coefficients, said first bit-shifting step consisting of shifting to the left the bits by a quantity given by the coefficients of a shift matrix, for generating primary shifted DCT coefficients. Each DCT coefficient in a given DCT block situated at a given row and column is associated with the shift coefficient in the shift matrix having the same row and column. When a DCT coefficient is shifted to the left, the new LSBs are filed with zeros.

This method comprises a second bit-shifting step 403 applied to said primary shifted DCT coefficients, said second bit-shifting step consisting of shifting to the right the bits by a quantity N1, for generating secondary shifted DCT coefficients. The shift to the right of N1 units is applied to all DCT coefficients in order to define the DCT coefficients defining the base layer.

The quantity N1 corresponds to the addition of an integral quantity K to the larger shift coefficient Smax in the shift matrix. To compensate the shift of K units, a requantization step 404 is performed for requantizing the input quantization factor associated with DCT coefficients, for generating a requantized output quantization factor, said requantization step consisting of multiplying the input quantization factor by a factor equal to 2^{K}.

This method also comprises a variable-length coding step 405 applied to said secondary shifted DCT coefficients, for generating variable-length coded DCT coefficients defining said base layer with an improved coding efficiency. This step may consists of a look-up table operation between an input DCT coefficient and an output DCT coefficient resulting from a coding using, for example, Huffman codes. It allows a decrease of the number of bits of the base layer.

This method also comprises a bit-plane coding step 406 applied to the N1 (K+Smax) bit planes composed from the N1 least significant bits of said primary shifted DCT coefficients, for generating coded bit planes defining N1 enhancement layers.

To this end, bit planes can be converted in 2-D symbols by the known coding method (RUN, EOP) as described in the MPEG-4 standard document referred to as ISO/IEC 14496-2/AMD 4, and previously described with reference to FIG. 3.

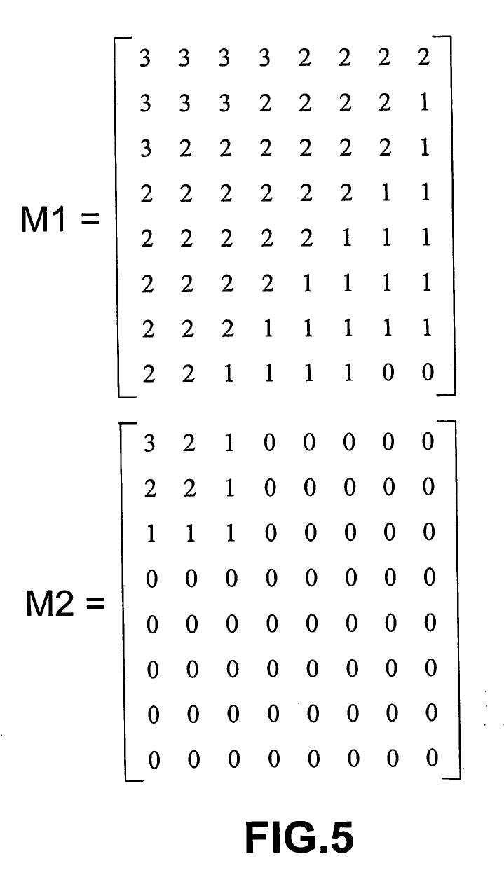

FIG. 5 depicts non-restrictive examples of shift matrixes M1 and M2 used in the methods according to the invention.

Each matrix M1 and M2 contains a set of 8*8 shift coefficients having varying integers. In particular, shift coefficients situated in the upper left corner are larger than the shift coefficients situated in the lower right corner. Indeed, shift coefficients situated in the upper left corner are dedicated to shifting low frequency DCT coefficients that must be preserved for ensuring a good video quality, while shift coefficients situated in the lower right corner are dedicated to shifting high frequency DCT coefficients that can be dampened.

Advantageously, an adaptive change of the shift matrix coefficients can be performed for reaching a given bit rate target of the base layer. Such an adaptive change of the shift matrix coefficients can particularly be based on the value of the quantization factor being used for the coded picture, the complexity of the coded picture, or the coded picture type. For example, an adaptive scheme could consist of:
on INTRA coded pictures for which no temporal prediction has been performed: fill the shift matrix with large shift coefficients for low frequency DCT coefficients and with smaller shift coefficients for high frequency DCT coefficients,
on INTER coded pictures for which a temporal prediction has been performed: fill the shift matrix with smaller shift coefficients for low frequency DCT coefficients compared to the shift coefficients for low frequency DCT coefficients defined for INTRA pictures, and with smaller shift coefficients for high frequency DCT coefficients.
   While dampening DCT coefficients, this scheme would ensure maintaining a good video quality on INTRA pictures, and as a consequence on INTER pictures.

Another adaptive scheme could consist of modifying the shift coefficients of the shift matrix for dampening DCT coefficients of the base layer in order to reach a given bit rate target of said base layer. In case the bitrate were too high, the adaptation could be done by increasing the shift coefficients amplitude difference between the shift coefficients associated with high frequency DCT coefficients and the shift coefficients associated with low frequency DCT coefficients. Otherwise, in case the bitrate were too low, the adaptation could be done by decreasing the shift coefficient amplitude difference between the shift coefficients associated with high frequency DCT coefficients and the shift coefficients associated with low frequency DCT coefficients.

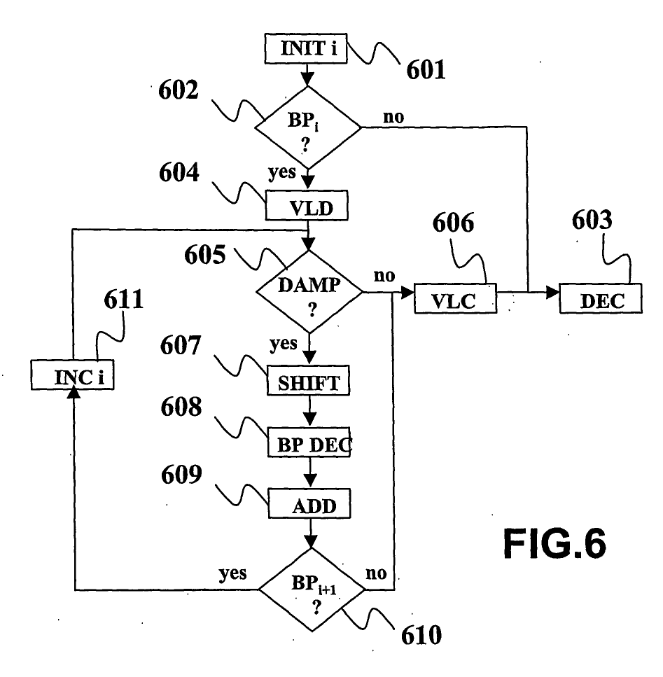

FIG. 6 is a diagram depicting the steps of a second method according to the invention for generating a non-scalable coded video signal from a scalable coded video signal generated by the first method of modifying depicted in FIG. 3.

The method comprises an initialization step 601 for initializing an index i to the value 1, the index i identifying the rank of the enhancement layer carrying the bit plane BP1 of rank i.

The method also comprises a detection step 602 for detecting if at least one enhancement layer has been received, the base layer being considered received. If no enhancement layers are received, the base layer can be exploited itself as a non-scalable coded video signal and can be decoded, for example, by a standard MPEG decoding step 603.

The method also comprises a variable-length decoding step 604 applied to said DCT coefficients defining the received base layer, for generating variable-length decoded DCT coefficients. This step may consist of a look-up table operation between an input DCT coefficient resulting from a coding using, for example, Huffman codes, and an output DCT coefficient.

The method also comprises a detection step 605 for detecting if the variable-length decoded DCT coefficients of the base layer are dampened. Such information can be deduced from the shift matrix that is available, for example, by sending it separately with the scalable coded video signal generated by means of the method of modifying described above with reference to FIG. 3, or locally stored. Indeed, it can be assumed that for a given DCT coefficient, if its number of missing bits is equal to the associated shift coefficient of the shift matrix (which can be known in decoding the available enhancement layers containing bit planes), and that these missing bits equal zero, the DCT coefficient is not dampened. Otherwise, the DCT coefficient is considered as being dampened.

For DCT coefficients considered as not being dampened, they can be first passed through a variable-length coding step 606 before being decoded in the standard decoding step 603.

For DCT coefficients considered as being dampened, the method also comprises a bit-shifting step 607 applied to said variable-length decoded DCT coefficients, said bit-shifting step consisting of shifting to the left by one unit the bits of said variable-length decoded DCT coefficients, for generating primary shifted DCT coefficients.

The method also comprises a bit-plane decoding step 608 for decoding the enhancement layer detected by detection step 602, for generating a decoded bit plane defining primary decoded values. This step may consist of decoding the coded bit planes that have been coded, for example, according to the (RUN, EOP) method described above. In particular, such a bit-plane decoding step comprises a variable-length decoding step applied to the 2D-symbols, and a step for generating the “0” and “1” strings from the variable-length decoded 2D-symbols.

The method also comprises an addition step 609 for adding said primary shifted DCT coefficients to said primary decoded values, for generating decoded values defining the non-scalable output video signal.

The method also comprises a detection step 610 for detecting if another enhancement layer is available, i.e. if additional bits of bit planes can be added to a previously modified DCT coefficient. The DCT coefficients for which no more bits of enhancement layers are available can be first passed through the variable-length coding step 606 before being decoded in the standard decoding step 603. If another enhancement layer is detected, the process is started again from the detection step 605 for DCT coefficients considered as being still dampened, and it is repeated a number of times equal to the number of enhancement layers, which is symbolized by the incrementing step 611 of index i.

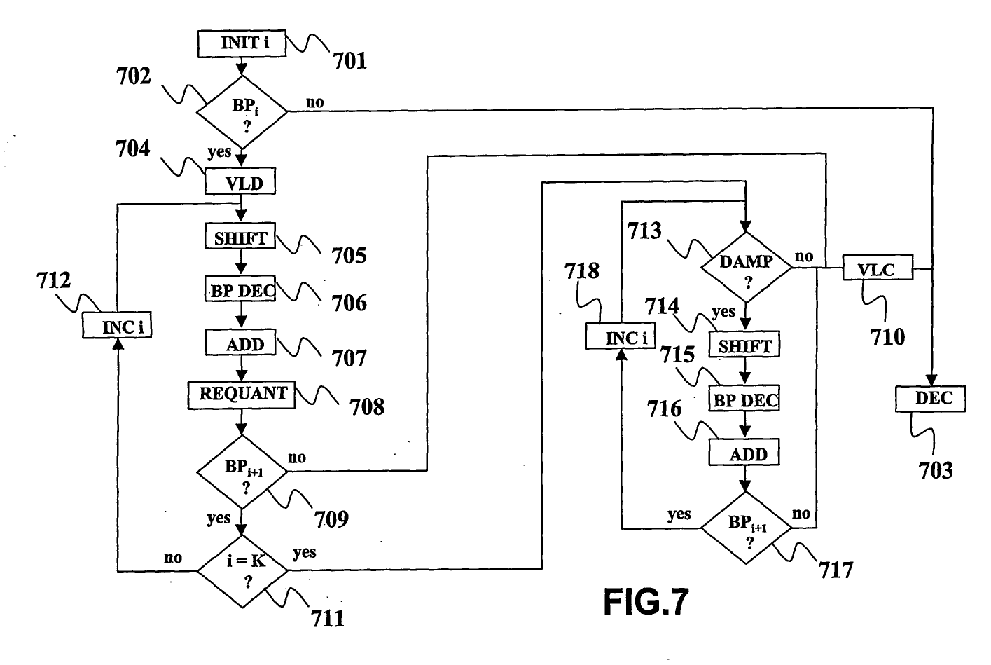

FIG. 7 is a diagram depicting the steps of a third method according to the invention for generating a non-scalable coded video signal from a scalable coded video signal generated by means of the first method of modifying depicted in FIG. 4.

The method comprises an initialization step 701 for initializing an index i to the value 1, the index i identifying the rank of the enhancement layer carrying the bit plane BPᵢ of rank i.

The method also comprises a detection step 702 for detecting if at least one enhancement layer has been received, the base layer being considered received. If no enhancement layers are received, the base layer can be exploited itself as a non-scalable coded video signal and can be decoded, for example, by a standard MPEG decoding step 703.

The method also comprises a variable-length decoding step 704 applied to said DCT coefficients defining the received base layer, for generating variable-length decoded DCT coefficients. This step may consist of a look-up table operation between an input DCT coefficient resulting from a coding using, for example, Huffman codes, and an output DCT coefficient.

The method also comprises a first bit-shifting step 705 applied to said variable-length decoded DCT coefficients, said first bit-shifting step consisting of shifting to the left by one unit the bits of variable-length decoded DCT coefficients, for generating primary shifted DCT coefficients.

The method also comprises a bit-plane decoding step 706 for decoding the enhancement layer, for generating a decoded bit plane defining primary decoded values. The bit-plane decoding step 706 is the same as the step 608 described for the method based on FIG. 6, i.e. it may correspond to a step for decoding 2D-symbols coded according to the (RUN, EOP) method.

The method also comprises a first addition step 707 for adding the primary decoded values to said primary shifted DCT coefficients, for generating modified DCT coefficients.

To compensate the addition done by step 707, the method also comprises a requantization step 708 for requantizing the input quantization factor associated with DCT coefficients and generating an output quantization factor, said requantization step consisting of dividing the input quantization factor by two each time the addition step 707 is performed.

The method also comprises a detection step 709 for detecting if another enhancement layers has been received. If no more enhancement layers are detected, the DCT coefficients of the base layer defining a non-scalable coded video signal can first be passed through a variable-length coding step 710 and then be decoded by the standard video decoding step 703. If an another enhancement layer is detected, a detection step 711 checks if the recursive set of steps composed of steps 705-706-707-708-709 must be performed again. If another enhancement layer is effectively detected, the incrementing step 712 increments the index i. The first set of recursive steps is performed at a maximum a number of times equal to a given quantity K, said quantity corresponding to the number of bit planes resulting from the quantization step 404 of the method described with reference to FIG. 4. This quantity K is sent separately with the scalable coded video signal generated by the first method of modifying described above, or locally stored.

After having inserted in the LSBs of the base layer DCT coefficients the bit planes corresponding to requantized information, a second set of steps is performed for inserting the other bit planes in the LSBs of dampened DCT coefficients, the dampened DCT coefficients being detected by the detecting step 713. To know if DCT coefficients are dampened, this can be deduced from the shift matrix that is available, for example, by sending it separately with the scalable coded video signal generated by means of the method of modifying described above with reference to FIG. 4, or locally stored. Indeed, it can be assumed that for a given DCT coefficient, if its number of missing bits is equal to the associated shift coefficient of the shift matrix (which can be known in decoding the available enhancement layers containing bit planes), and that these missing bits equal zero, then the DCT coefficient is not dampened. Otherwise, the DCT coefficient is considered as being dampened.

For DCT coefficients considered as not being dampened, they can be first passed through the variable-length coding step 710 before being decoded in the video standard decoding step 703.

For DCT coefficients considered as being dampened, the method also comprises a bit-shifting step 714 applied to said variable-length decoded DCT coefficients, said bit-shifting step consisting of shifting to the left by one unit the bits of said variable-length decoded DCT coefficients, for generating secondary shifted DCT coefficients.

The method also comprises a bit-plane decoding step 715 for decoding the remaining enhancement layers, for generating a decoded bit plane defining secondary decoded values. This step 715 may consist of decoding the coded bit planes that have been coded, for example, according to the (RUN, EOP) method described above. In particular, such a bit-plane decoding step comprises a variable-length decoding step applied to the 2D-symbols, and a step for generating the “0” and “1” strings from the variable-length decoded 2D-symbols.

The method also comprises a second addition step 716 for adding said secondary shifted DCT coefficients to said secondary decoded values, for generating decoded values defining the non-scalable output video signal.

The method also comprises a detection step 717 for detecting if another enhancement layer is available, i.e. if additional bits of bit planes can be added to a previously modified DCT coefficient. The DCT coefficients for which no more bits of enhancement layers are available can be first passed through the variable-length coding step 710 before being decoded in the standard decoding step 703. If another enhancement layer is detected, the process is started again from the detection step 713 for DCT coefficients considered as being still dampened, and it is repeated a number of times equal to the number of enhancement layers, which is symbolized by the incrementing step 718 of index i.

The following is an illustration of the methods as described with reference to FIGS. 3-4-6-7. To ease the understanding, only three DCT coefficients are considered in association with the first three shift coefficients of the shift matrix M, but the same principle would apply to all DCT coefficients within a 8*8 DCT block.

Suppose the DCT block is composed of 3 coefficients (A=a1 a2 a3, B=b1 b2 b3, C=c1 c2 c3) where ai, bᵢ, cᵢ are the bit values of said coefficients:

| | | |
|---|---|---|
| a1 | a2 | a3 |
| b1 | b2 | b3 |
| c1 | c2 | c3 |

A, B and C are quantized DCT coefficients, and the associated quantization factor Q is equal to Q=Q0.

For example, the shift matrix M is such that

$$M = [ \begin{matrix}2 \\ 1 \\ 0\end{matrix} ]$$

In that case, the maximum shift coefficient is Smax=2.

1) Encoding Without Requantization:

These explanations relate to the first method of modifying based on FIG. 3.

The bit shifting by step 302 of the input DCT coefficients with matrix M leads to:

| | | | | |
|---|---|---|---|---|
| a1 | a2 | a3 | 0 | 0 |
| | b1 | b2 | b3 | 0 |
| | | c1 | c2 | c3 |

After bit shifting by step 303 with N1=Smax=2, the DCT coefficients for the base layer are given by:

| | | |
|---|---|---|
| a1 | a2 | a3 |
| | b1 | b2 |
| | | c1 |

Thus, in the base layer, the coefficients b and c have been dampened (divided by 2 and 4, respectively, according to the shift matrix M) compared to their original values.

There are 2 enhancement layers defined by bit planes

$$BP1 = [ \begin{matrix}• \\ b3 \\ c2\end{matrix} ] , BP2 = [ \begin{matrix}• \\ • \\ c3\end{matrix} ] .$$

where a • indicates that the bit at this position is equal to a zero, and that depending on the bit-plane coding method, such a bit is transmitted or not.
2) Encoding with Requantization:

These explanations relate to the first method of modifying based on FIG. 4. Suppose that the requantization is such that an extra shift of two bits is performed, i.e. K=2. The bit shifting by step 402 of the input DCT coefficients with matrix M leads to:

| | | | | |
|---|---|---|---|---|
| a1 | a2 | a3 | 0 | 0 |
| | b1 | b2 | b3 | 0 |
| | | c1 | c2 | c3 |

After bit shifting by step 403 with N1=(K+Smax)=4, the DCT coefficient for the base layer is given by:

a1
0
0

The quantization factor associated with this DCT coefficient for the base layer is Q=Q0*2^{K}=4*Q0, thanks to the requantization step 404.

There are 4 enhancement layers defined by bit planes

$$BP1 = [ \begin{matrix}a2 \\ b1 \\ •\end{matrix} ] , BP2 = [ \begin{matrix}a3 \\ b2 \\ c1\end{matrix} ] , BP3 = [ \begin{matrix}• \\ b3 \\ c2\end{matrix} ] and BP4 = [ \begin{matrix}• \\ • \\ c3\end{matrix} ] .$$

3) Decoding without Requantization:

These explanations relate to the second method of modifying based on FIG. 6, assuming that the received base layer and enhancement layers are generated by the method of modifying based on FIG. 3.

The available base layer coefficients associated with Q=Q0 are:

| | | |
|---|---|---|
| a1 | A2 | a3 |
| | B1 | b2 |
| | | c1 |

It can be assumed that coefficients b and c are dampened.

After receiving the first enhancement bit plane BP1, the DCT coefficients are reconstructed as:

| | | |
|---|---|---|
| a1 | a2 | a3 |
| b1 | b2 | b3 |
| | c1 | c2 |

Using the knowledge of the shift matrix, it can be known that no more bits need to be received for coefficient a (and no more for b in the subsequent bit planes BP2). Thus, the coefficient values for b and c have been shifted to the left and the correct bit values have been inserted at the LSB positions. Coefficient b is now neither dampened anymore.

After receiving the second enhancement bit plane BP2, the coefficients are then finally completely reconstructed as:

| | | |
|---|---|---|
| a1 | a2 | A3 |
| b1 | b2 | B3 |
| c1 | c2 | C3 |

Quantized coefficients C1, C2 and C3 are recovered and are associated with the quantization factor Q=Q0.

Note that the incomplete coefficients are dampened. If all enhancement layers are present, the decoded coefficients are exactly the same of the original stream. If one or a plurality of enhancement layers are lost, the decoded coefficient is dampened (by a factor of 2 if one enhancement layer is lost, 4 if 2 enhancement layers are lost, . . . , 2^{k} if k enhancement layers are lost) compared to the original stream.

4) Decoding with Requantization:

These explanations relate to the third method of modifying based on FIG. 7, assuming that the received base layer and enhancement layers are generated by means of the method of modifying based on FIG. 4.

The available base layer coefficient associated with Q=4*Q0 is:

a1
0
0

The data of the enhancement bit plane BP1 is added by step 707 for obtaining the following DCT coefficients associated with Q=2*Q0 (Q has been halved):

| a1 | a2 |
|---|---|
| | b1 |
| | 0 |

Note that coefficient b is dampened by a factor of 2, according to the shift matrix M. Then, the data of the enhancement bit plane BP2 is added by step 707 for obtaining the following DCT coefficients associated with Q=Q0 (Q has been halved):

| a1 | a2 | a3 |
|---|---|---|
| | b1 | b2 |
| | 0 | c1 |

Since no more requantized data is available (K=2), the quantizer step Q will now remain at Q0 and decoding continues as in the case without requantization.

The modification of dampened DCT coefficients (i.e. coefficients A and B) is continued by inserting bits of the bit plane BP3 by step 716 for obtaining the following coefficients:

| a1 | a2 | a3 |
|---|---|---|
| b1 | b2 | b3 |
| 0 | c1 | c2 |

The modification of dampened DCT coefficients (i.e. coefficient C) is continued by inserting bits of the bit plane BP3 by step 716 for obtaining the following coefficients:

| | | |
|---|---|---|
| a1 | a2 | a3 |
| b1 | b2 | b3 |
| c1 | c2 | c3 |

This first method of modifying can be implemented in a video encoder, while the second and third methods of modifying can be implemented in a video decoder such as in a set-top box product dedicated to the reception and processing of coded audio/video signals. To this end, by hardware components, these methods can be implemented such as by means of wired electronic circuits (RAM memories for VLC and VLD look-up tables, or for storing video frames during motion compensation steps, shift registers for shifting steps), or, alternatively, by means of a set of instructions stored in a computer-readable medium, said instructions replacing at least a portion of said circuits and being executable under the control of a computer or a digital processor in order to carry out the same functions as fulfilled in said replaced circuits.

The invention also relates to a scalable coded signal generated by means of the first method according to the invention, said scalable signal resulting from a double shifting step applied on DCT coefficients.

The invention also relates to a storage medium carrying a scalable coded signal generated by means of the first method according to the invention, said scalable signal resulting from a double shifting step applied on DCT coefficients.

The invention also relates to a first computer program comprising code instructions for implementing the steps of the first method of modifying according to the invention presented above, said first computer program being used by a signal processor.

The invention also relates to a second computer program comprising code instructions for implementing the steps of the second method of modifying according to the invention presented above, said second computer program being used by a signal processor.

The invention also relates to a third computer program comprising code instructions for implementing the steps of the third method of modifying according to the invention presented above, said third computer program being used by a signal processor.

1. A method of modifying a non-scalable input coded video signal comprising blocks of input coefficients, said input coefficients being quantized by an input quantization factor, for generating a scalable output coded video signal comprising a base layer and a set of enhancement layers, characterized in that the method of modifying comprises:
a first bit-shifting step applied to said input coefficients, said first bit-shifting step consisting of shifting to the left the bits by a quantity given by the coefficients of a shift matrix, for generating primary shifted coefficients,
a second bit-shifting step applied to said primary shifted coefficients, said second bit-shifting step consisting of shifting to the right the bits by a quantity N1, for generating secondary shifted coefficients,
a variable-length coding step applied to said secondary shifted coefficients, for generating variable-length coded coefficients defining said base layer,
a bit-plane coding step for coding the bit planes composed from the N1 least significant bits of said primary shifted coefficients, for generating coded bit planes defining said enhancement layers.

2. A method as claimed in claim 1 characterized in that N1 corresponds to the larger coefficient in said shift matrix.

3. A method as claimed in claim 1 characterized in that:
N1 corresponds to the addition of a quantity K to the larger coefficient in said shift matrix,
it comprises a requantization step for requantizing the input quantization factor, for generating a requantized output quantization factor, said requantization step consisting of multiplying the input quantization factor by a factor equal to 2^{K}.

4. A method of modifying a scalable input coded video signal comprising a base layer and a set of enhancement layers, for generating a non-scalable output video signal, said base layer comprising blocks of input coefficients, characterized in that said method of modifying comprises the following recursive set of steps, for each enhancement layer:
a bit-shifting step applied to said input coefficients, said bit-shifting step consisting of shifting to the left by one unit the bits of input coefficients considered as being dampened, for generating primary shifted coefficients,
a bit-plane decoding step for decoding the enhancement layer, for generating a decoded bit plane defining primary decoded values,
an addition step for adding said primary shifted coefficients to said primary decoded values, for generating decoded values defining the non-scalable output video signal,
the set of recursive steps being performed a number of times equal to the number of enhancement layers.

5. A method of modifying a scalable input coded video signal comprising a base layer and a set of enhancement layers, for generating a non-scalable output video signal, said base layer comprising blocks of input coefficients quantized by an input quantization factor, characterized in that said method of modifying comprises:
a) a first set of recursive steps comprising, for each enhancement layer:
a first bit-shifting step applied to said input coefficients, said first bit-shifting step consisting of shifting to the left by one unit the bits of input coefficients, for generating primary shifted coefficients,
a bit-plane decoding step for decoding the enhancement layer, for generating a decoded bit plane defining primary decoded values,
a first addition step for adding the primary decoded values to said primary shifted coefficients, for generating modified coefficients,
a requantization step for requantizing the input quantization factor and generating an output quantization factor, said requantization step consisting of dividing the input quantization factor by two,
the first set of recursive steps being performed at a maximum a number of timed equal to a given quantity K,
b) a second set of recursive steps comprising, for each enhancement layer:
a second bit-shifting step applied to said modified coefficients, said second bit-shifting step consisting of shifting to the left by one unit the bits of modified decoded coefficients considered as being dampened, for generating secondary shifted coefficients,
a bit-plane decoding step for decoding the enhancement layer for generating a decoded bit plane defining secondary decoded values,
a second addition step for adding said secondary shifted coefficients to said secondary decoded values, for generating decoded values defining the non-scalable output video signal, the second set of recursive steps being performed a number of times equal to the remaining enhancement layers.

6. A method as claimed in claim 4 or 5 characterized in that it also comprises:
a variable-length coding step applied to said decoded values defining the output video signal, for generating variable-length coded coefficients,
a standard video decoding for decoding said variable-length coded coefficients, for generating a decoded video signal of said non-scalable output video signal.

7. An encoder for modifying a non-scalable input coded video signal comprising blocks of input coefficients, said input coefficients being quantized by an input quantization factor, for generating a scalable output coded video signal comprising a base layer and a set of enhancement layers, characterized in that said encoder comprises:
first bit shifting means applied to said input coefficients, said first bit shifting means consisting of shifting to the left the bits by a quantity given by the coefficients of a shift matrix, for generating primary shifted coefficients,
second bit shifting means applied to said primary shifted coefficients, said second bit shifting means consisting of shifting to the right the bits by a quantity N1, for generating secondary shifted coefficients,
variable-length coding means applied to said secondary shifted coefficients, for generating variable-length coded coefficients defining said base layer,
bit-plane coding means for coding the bit planes composed from the N1 least significant bits of said primary shifted coefficients, for generating coded bit planes defining said enhancement layers.

8. A decoder for modifying a scalable input coded video signal comprising a base layer and a set of enhancement layers, for generating a non-scalable output video signal, said base layer comprising blocks of input coefficients, characterized in that said decoder comprises the following set of means used recursively, for each enhancement layer:
bit shifting means applied to said input coefficients, said bit shifting means consisting of shifting to the left by one unit the bits of input coefficients considered as being dampened, for generating primary shifted coefficients,
bit-plane decoding means for decoding the enhancement layer, for generating a decoded bit plane defining primary decoded values,
addition means for adding said primary shifted coefficients to said primary decoded values, for generating decoded values defining the non-scalable output video signal,
the set of means used recursively being performed a number of times equal to the number of enhancement layers.

9. A decoder for modifying a scalable input coded video signal comprising a base layer and a set of enhancement layers, for generating a non-scalable output video signal, said base layer comprising blocks of input coefficients quantized by an input quantization factor, characterized in that said decoder comprises:
a) a first set of means used recursively comprising, for each enhancement layer:
first bit shifting means applied to said input coefficients, said first bit shifting means consisting of shifting to the left by one unit the bits of input coefficients, for generating primary shifted coefficients,
bit-plane decoding means for decoding the enhancement layer, for generating a decoded bit plane defining primary decoded values,
first addition means for adding the primary decoded values to said primary shifted coefficients, for generating modified coefficients,
requantization means for requantizing the input quantization factor and generating an output quantization factor, said requantization means consisting of dividing the input quantization factor by two,
the first set of means used recursively being performed at a maximum a number of times equal to a given quantity K,
b) a second set of means used recursively comprising, for each enhancement layer:
second bit shifting means applied to said modified coefficients, said second bit shifting means consisting of shifting to the left by one unit the bits of modified decoded coefficients considered as being dampened, for generating secondary shifted coefficients,
bit-plane decoding means for decoding the enhancement layer for generating a decoded bit plane defining secondary decoded values,
second addition means for adding said secondary shifted coefficients to said secondary decoded values, for generating decoded values defining the non-scalable output video signal,
the second set of means used recursively being performed a number of times equal to the remaining enhancement layers.

10. A set-top box product for receiving and processing a scalable coded video signal, comprising a decoder as claimed in claim 8 or 9.

11. A scalable coded video signal comprising a base layer and a set of enhancement layers, said signal resulting from a method of modifying a non-scalable input coded video signal comprising blocks of input coefficients, said input coefficients being quantized by an input quantization factor, said method of modifying comprising:
a first bit-shifting step applied to said input coefficients, said first bit-shifting step consisting of shifting to the left the bits by a quantity given by the coefficients of a shift matrix, for generating primary shifted coefficients,
a second bit-shifting step applied to said primary shifted coefficients, said second bit-shifting step consisting of shifting to the right the bits by a quantity N1, for generating secondary shifted coefficients,
a variable-length coding step applied to said secondary shifted coefficients, for generating variable-length coded coefficients defining said base layer,
a bit-plane coding step for coding the bit planes composed from the N1 least significant bits of said primary shifted coefficients, for generating coded bit planes defining said enhancement layers.

12. A storage medium having stored thereon a scalable coded video signal comprising a base layer and a set of enhancement layers, said signal resulting from a method of modifying a non-scalable input coded video signal comprising blocks of input coefficients, said input coefficients being quantized by an input quantization factor, said method of modifying comprising:
a first bit-shifting step applied to said input coefficients, said first bit-shifting step consisting of shifting to the left the bits by a quantity given by the coefficients of a shift matrix, for generating primary shifted coefficients,
a second bit-shifting step applied to said primary shifted coefficients, said second bit-shifting step consisting of shifting to the right the bits by a quantity N1, for generating secondary shifted coefficients,
a variable-length coding step applied to said secondary shifted coefficients, for generating variable-length coded coefficients defining said base layer,
a bit-plane coding step for coding the bit planes composed from the N1 least significant bits of said primary shifted coefficients, for generating coded bit planes defining said enhancement layers.

13. A computer program comprising code instructions for implementing the steps of one of the methods as claimed in claim 1, 4 or 5.
